(19) United States
(12) Patent Application Publication
(10) Pub. No.: US 2007/0090327 A1
(43) Pub. Date: Apr. 26, 2007

(54) Novel red fluorescent powder

(75) Inventors: I-Min Chan, Hsinchu Hsien (TW); Sheng-Bang Huang, Hsinchu (TW); Chuang-Bang Chiu, Hsinchu (TW); Teng-Ming Chen, Hsinchu (TW); Yuan-Cheng Chin, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/453,041

(22) Filed: Jun. 15, 2006

(30) Foreign Application Priority Data
Oct. 4, 2005 (TW) 094134616

(51) Int. Cl. C09K 11/68; H01J 1/62

(52) U.S. Cl. 252/301.5; 257/98; 313/503; 423/263

(57) ABSTRACT

A novel red fluorescent powder of the following formula (I):
AB(MO₄)₂ (I)
wherein A is independently Li⁺, Na⁺, K⁺, Rb⁺, Cs⁺, or Ag⁺; B is Europium of trivalent rare-earth ion (Eu³⁺); and M is molybdenum (Mo) or tungsten(W). The red fluorescent powder prepared by a solid-state method is used in light emitted diodes (LED), particular in white light LEDs. It has strong absorption in the near-UV wavelength of 360 nm to 420 nm, improved luminescence intensity than commercially available, high color purity, luminescent efficiency, and excellent chemical stability.

### FIELD OF THE INVENTION

The present invention relates to a red fluorescent powder, and more particularly, the invention relates to a red fluorescent powder suitable for use in white light emitting diodes, and a process for preparing the same.

### BACKGROUND OF THE INVENTION

Fluorescent powder has been applied widely to various common luminescent devices, such as TV image tubes, display image tubes, monitor image tubes, radar, flying spot scanner image boosters, printer image tubes, vacuum fluorescent display tubes, plasma displays, illumination devices, traffic signals, fluorescent plates, intensifying screens, light emitting diodes (LEDs), etc. Recently, research on fluorescent powder has paid much attention to factors influencing display quality such as resolution, brightness, and the like. Illumination devices needing high brightness are also in demand.

An LED is a solid-state semiconductor component, using two separated charge carriers (referred to as electrons for negative charge and holes for positive charge) within the LED that combine with each other and emit light. The light-emitting principle for LEDs is different from the thermo-luminescence principle such as used in a tungsten light bulb. Operation of an LED depends on current flow instead of heat, and, as long as current flows through both sides of the LED component, it will emit light. The energy levels in an LED attained by electrons and holes differ depending on the fabrication material. The difference in energy levels affects the photon energy after recombination to emit diverse wavelengths of light, namely the colors of light such as red, orange, yellow, green, blue, or non-visible light. LEDs devices are commonly used in products for daily use, having advantages of lifespan, electrical efficiency, durability, earthquake resistance, non-fragility, portability, short response time, and the like, as well as ease of manufacture.

The earliest technology for a white LED, assigned to Nichia Kagaku Kogyo Kabushiki Kaisha, disclosed a method for mixing two colors of light having different wavelengths by using a layer of yellow light yttrium aluminum garnet (YAG) fluorescent powders coated on the surface of a 460 nm blue LED. The blue LED excites the YAG fluorescent powder to generate yellowish light of 555 nm wavelength that is complementary to the blue light. The blue light and the yellowish light are mixed through a lens principle to produce white light. A red object displays as a weak orange under irradiation of such a white LED, because it has a weak red wavelength region in the visible-light spectrum. Accordingly, in the case that such a white LED is used as an LCD backlight source, it needs to be color-corrected by a color filter to solve the chromatic polarization problem. Another known white LED disclosed a method for mixing three colors of light having different wavelength, using UV light emitted by an inorganic ultraviolet chip to excite R/G/B (red, green, and blue) fluorescent powders. When the R/G/B colors of light are in the appropriate ratio, the light produced will appear as white light. This process is low-cost, suitable for manufacture, and characterized by a uniform light without the problem of chromatic polarization. Moreover, the transform efficiency of the fluorescent materials employed is higher than yellow light YAG fluorescent powder, so as to increase the probability of improving the luminescent efficiency of white LEDs.

Fluorescent powders play a key role in transforming color during the preparation of a white LED. In the single-fluorescent-powder system, a monogram white LED made of a blue LED and YAG fluorescent powders has a problem at high color temperature, because some blue light must be incorporated to form the white light, especially with high current. Furthermore, the emission spectrum of such a white LED nearly doesn't contain any red element, so the color rendering index of about 70 to 80 is inappropriate for general illumination.

To solve the above-mentioned problem of low color rendering index, the industry has developed a system using a blue LED combined with red and green fluorescent powders to emit white light that is derived from the system for a white LED using a single fluorescent powder. In addition, red fluorescent powder (SrS:Eu or CaS:Eu) and YAG fluorescent powder (yttrium aluminum garnet-Y₃Al₅O₁₂) also can be used in the system to improve the color rendering index of such a white LED. Subsequently, a further development, disclosed by R. M. Mach et al., Lumileds Corporation, 2002, used red and green fluorescent powders, SrGa₂S₄:Eu²⁺ and SrS:Eu²⁺, in combination with a blue LED chip. This approach became one of the significant technologies used for white light LEDs because the color rendering index is up to 92, and, in addition, the efficiency can be as good as the method of only using YAG fluorescent powders. However, it is worthwhile to note that, although the red fluorescent powders of the sulfide series have high efficiency, they interact with moisture in the air easily and have heat instability.

Accordingly, it is desirable to use a red fluorescent powder that is not from the sulfide series that has excellent stability in blue, yellow-green and ultraviolet wavelengths, and that combines effectively with other fluorescent powders for use in a white light LED.

### SUMMARY OF THE INVENTION

Based on the shortcomings of the above prior art, the primary objective of the present invention is to provide a novel red fluorescent of high intensity and with good color performance. Such a red fluorescent powder has the following formula (I):
AB(MO₄)₂ (I)

wherein A is independently Li⁺, Na⁺, K⁺, Rb⁺, Cs⁺, or Ag⁺; B is Europium of trivalent rare-earth ion (Eu³⁺); and M is molybdenum (Mo) or tungsten(W). The red fluorescent powder prepared by a solid-state method is suitable for LEDs, particular in white light LEDs.

Because the red fluorescent powder of the invention is an oxide, differing from red fluorescent powders of the sulfide series commercially available, it has preferred chemical stability suitable for blue, yellow-green and ultraviolet (380 nm to 420 nm) wavelength region. Additionally, the red fluorescent powder of the present invention exhibits Eu³⁺ ions that are far from each other, which leads to the absence of the extinction phenomenon of Eu³⁺; therefore, its luminescent intensity is better than that commercially available, as well as its color purity and luminescent efficiency. In particular, the chromaticity coordinates of the produced light are up to (0.66, 0.33), and it has excellent color saturation.

In addition, the excitation wavelength of the LED is between 360 nm to 560 nm, among which, three preferred excitation wavelengths are near-UV of 394 nm wavelength, blue light of 465 nm wavelength, and yellow-green light of 545 nm wavelength, respectively. Particularly, the red fluorescent powder of the invention has strong absorption in near-UV wavelength of 360 nm to 420 nm.

### BRIEF DESCRIPTION OF THE DRAWINGS

FIG. 1 is the photoluminescence emission and excitation spectrum of LiEu(MoO₄)₂ formed by sintering at 800° C. of the present invention.

FIG. 2 is the photoluminescence emission and excitation spectrum of NaEu(MoO₄)₂ formed by sintering at 800° C. of the present invention.

FIG. 3 is the photoluminescence emission and excitation spectrum of KEu(MoO₄)₂ formed by sintering at 800° C. of the present invention.

FIG. 4 is the X-ray diffraction of KEu(MoO₄)₂ formed by sintering at 800° C. of the present invention.

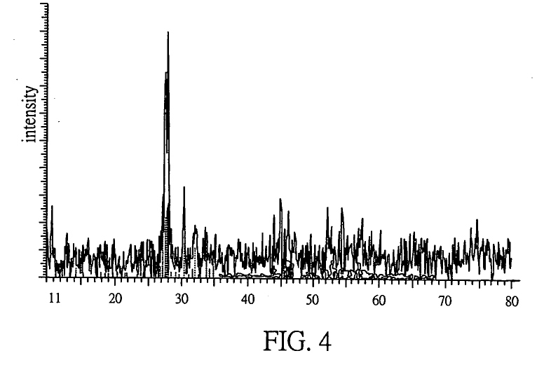

FIG. 5 is a figure of the chromaticity coordinates of AB(MoO₄)₂ of the present invention, and the chromaticity coordinates are (0.66, 0.33) under the near-UV excitation wavelength ranging from 370 nm to 410 nm.

### DETAILED DESCRIPTION OF THE PREFERRED EMBODIMENTS

The following examples illustrate particular embodiments of the invention; one skilled in the art can easily realize other embodiments according to the content of the specification disclosed. The invention can also be employed or applied by various embodiments; in view of different viewpoints and applications, the details of the specification are subject to a variety of the modifications and changes, without departing from the spirit and scope of the present invention.

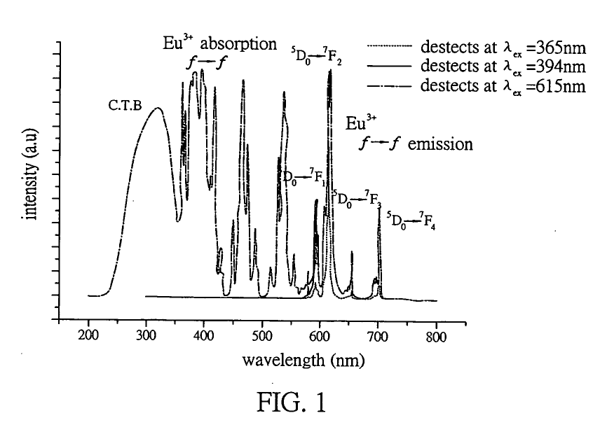

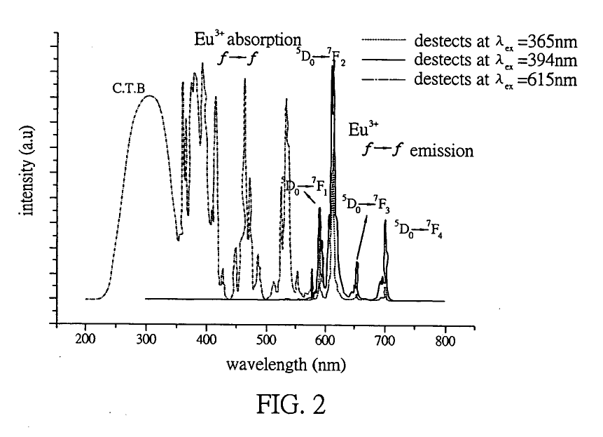

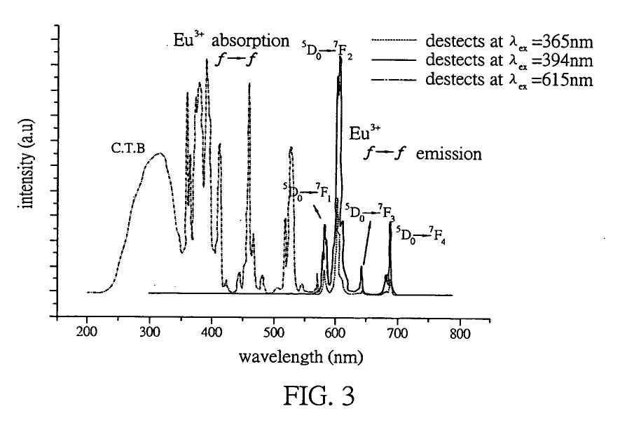

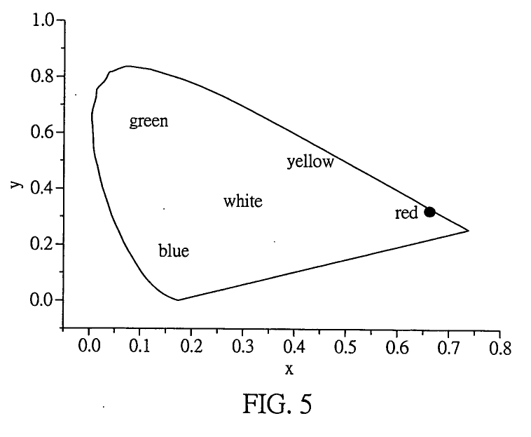

A novel red fluorescent powder of following formula (I) is provided in the present invention:
AB(MO₄)₂ (I)

wherein A is independently Li⁺, Na⁺, K⁺, Rb⁺, Cs⁺, or Ag⁺; B is Europium of trivalent rare-earth ion (Eu³⁺); and M is molybdenum (Mo) or tungsten (W). The red fluorescent powder can be prepared by a solid-state method and can be used in LEDs, particular in white LEDs. To obtain the preferred color effect, usage is also optionally applied with yellow, blue, or green light fluorescent powders. Additionally, the excitation wavelength of the LED is between 360 nm to 560 nm, among which, three preferred excitation wavelength are near-UV of 394 nm wavelength, blue light of 465 nm wavelength, and yellow-green light of 545 nm wavelength; and the LED has very strong absorption in near-UV wavelength of 360 nm to 420 nm. As demonstrated in FIG. 1 to FIG. 3, when A is Li⁺ and M is Mo in formula (I), the red fluorescent powder has strong absorption in the emission wavelength from 370 nm to 405 nm, and at 416 nm, 464 nm, and 535 nm; when A is Na⁺ and M is Mo in formula (I), the powder also exhibits strong absorption in the emission wavelength from 370 nm to 405 nm, as well as at 464 nm, but has lower absorption at 416 nm and 535 nm; and, when A is K⁺ and M is Mo in formula (I), the powder still has strong absorption in the emission wavelength from 370 nm to 405 nm, and at 464 nm, but has a lower absorption at 416 nm and 535 nm. In addition, as represented in FIG. 5, the red fluorescent powder of the invention, AB(MO₄)₂, shows excellent color purity under the near-UV emission wavelength from 370 nm to 410 nm; although its chromaticity coordinates (0.66, 0.33) are quite near that of others commercially available, ex. Kasei P22-RE3 (Y₂O₂S:Eu³⁺), the luminance (2.3 cd/m²) is higher than one (1.6 cd/m²). In addition, the fact that the Eu³⁺ ions are far from each other leads to the absence of the extinction phenomenon of Eu³⁺, so that the luminescence intensity and luminescent efficiency are better than commercially available, and its main emission wavelength is about 615 nm. Furthermore, the red fluorescent powder of the invention is an oxide, so it has a preferred chemical stability to the one in the sulfide series commercially available.

The red fluorescent powder of the invention is prepared by using a solid-state method, comprising the steps of: stoichiometrically measuring alkali metal carbonate or nitrate, trivalent rare-earth oxide, and molybdenum trioxide or tungsten dioxide; uniformly mixing and grinding these for 20 to 30 minutes; putting the mixed and ground result into an aluminum crucible; then placing the contents into a furnace and sintering at 600 to 800° C. for 5 to 10 hours. In addition, 5 wt % alkali metal tungstate or molybdenate also can be used as flux in the process, and the range for the replacement of Mo with W is 0 to 100 molar percent.

The red fluorescent powder of the present invention is used as a photoluminescence producer in a luminescent device. The luminescent device comprises the LED chip and the photoluminescence producer; wherein the photoluminescence producer absorbs at least a portion of the light emitted by the LED chip, and emits wavelength differing from the absorbed wavelength(s). During this time, the emission spectrum of the LED has a main peak between 360 nm to 560 nm, and the photoluminescence activated by Eu³⁺can be used in combination with yellow, blue, or green light fluorescent powders to achieve the preferred color effect for the resultant light emitted by the device.

### EXAMPLE

### Example 1

### Preparation of the Red Fluorescent Powder (LiEu(MoO₄)₂):

A red fluorescent powder is prepared by using a solid-state method. First, 0.0738 g of lithium carbonate, 0.3514 g of europium oxide, and 0.5749 g of molybdenum trioxide are measured and placed into a mortar, mixed uniformly and ground for 20 to 30 minutes. Then, the powders are put into a crucible made of aluminum oxide, conducted in sintering at 600 to 800° C. After six hours, the red fluorescent material, LiEu(MoO₄)₂, as the title describes, is obtained.

### Example 2

### Preparation of the Red Fluorescent Powder (LiEu(WO₄)₂):

A red fluorescent powder is prepared by using a solid-state method. First, 0.0546 g of lithium carbonate, 0.2601 g of europium oxide, and 0.6853 g of molybdenum trioxide are measured and placed into a mortar, mixed uniformly and ground for 20 to 30 minutes. Then, the powders are put into a crucible made of aluminum oxide, conducted in sintering at 600 to 800° C. After six hours, the red fluorescent material, LiEu(WO₄)₂, as the title describes, is obtained.

1. A red fluorescent powder of the following formula (I), useful in light emitted diodes (LEDs):
AB(MO₄)₂ (I)
wherein A is independently Li⁺, Na⁺, K⁺, Rb⁺, Cs⁺, or Ag⁺; B is Europium of trivalent rare-earth ion (Eu³⁺); and M is molybdenum (Mo) or tungsten(W).

2. The red fluorescent powder of claim 1 being used in a white-light LED.

3. The red fluorescent powder of claim 1, wherein the estimation of replacing Mo with W is 0 to 100 molar percent.

4. The red fluorescent powder of claim 3 being used in a white-light LED.

5. The red fluorescent powder of claim 1, wherein the excitation wavelength used for the LED is between 360 nm to 560 nm.

6. The red fluorescent powder of claim 5 being used in a white-light LED.

7. The red fluorescent powder of claim 5, wherein the excitation wavelength used for the LED, comprising: near-UV of 394 nm wavelength, blue light of 465 nm wavelength, and yellow-green light of 545 nm wavelength, respectively.

8. The red fluorescent powder of claim 7 being used in a white-light LED.

9. The red fluorescent powder of claim 1, wherein the chromaticity coordinates of red light are up to (0.66, 0.33).

10. The red fluorescent powder of claim 9 being used in a white-light LED.

11. The red fluorescent powder of claim 1, wherein the main emission wavelength is about 615 nm.

12. The red fluorescent powder of claim 11 being used in a white-light LED.

13. A process for preparing the red fluorescent powder of claim 1, comprising the steps of:
stoichiometrically measuring alkali metal carbonate or nitrate, trivalent rare-earth oxide, and molybdenum trioxide or tungsten trioxide;
mixing these uniformly and grinding for 20 to 30 minutes;
placing the mixed and ground result into an aluminum crucible; and
placing the result in a furnace, conducted in sintering at 600 to 800° C. for 5 to 10 hours.

14. The process of claim 13, wherein the graining time is between 20 to 30 minutes.

15. The process of claim 13, wherein the sintering temperature of furnace is between 600 to 800° C.

16. The process of claim 13, wherein the sintering time of the furnace is between 5 to 10 hours.

17. The process of claim 13, wherein 5 wt % alkali metal tungstate or alkali metal molybdenate also can be used as flux.

18. A luminescent device using the red fluorescent powder of claim 1 as a photoluminescence producer; further comprising an LED chip, wherein the photoluminescence producer absorbs at least a part of the light emitted by the LED chip, and emits wavelength(s) differing from the absorbed wavelength(s).

19. The device of claim 18, wherein the photoluminescence producer also can be optionally used in combination with yellow, blue, or green fluorescent powders.

20. The device of claim 18, wherein the emission spectrum of the LED chip has its main peak between 360 nm to 560 nm.

21. The device of claim 20, wherein the photoluminescence producer also can be optionally used in combination with yellow, blue, or green fluorescent powders.

22. The device of claim 18, wherein the photoluminescence is activated by europium ions (Eu³⁺).

23. The device of of claim 22, wherein the photoluminescence producer also can be optionally used in combination with yellow, blue, or green fluorescent powders.
